(19) United States
(12) Patent Application Publication
(10) Pub. No.: US 2011/0271194 A1
(43) Pub. Date: Nov. 3, 2011

(54) VOICE AD INTERACTIONS AS AD CONVERSIONS

(75) Inventors: Jennifer W. Lin, Mountain View, CA (US); Ping Wu, San Bruno, CA (US)

(73) Assignee: GOOGLE INC., Mountain View, CA (US)

(21) Appl. No.: 12/770,663

(22) Filed: Apr. 29, 2010

(51) Int. Cl. G06F 3/16; G10L 15/26

(52) U.S. Cl. 715/728; 704/235; 704/E15.043

(57) ABSTRACT

This specification describes technologies relating to content presentation. In general, one aspect of the subject matter described in this specification can be embodied in methods that include the actions of presenting a content item to a user; receiving a user input indicating a voice interaction; receiving a voice input from the user; transmitting the voice input to a content system; receiving a command responsive to the voice input; and executing, using one or more processors, the command including modifying the content item. Other embodiments of this aspect include corresponding systems, apparatus, and computer program products.

### BACKGROUND

The present disclosure relates to content presentation.

Advertisers provide advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can include an ad in a webpage, for example, in response to one or more keywords in a user search query input to a search engine. If a user selects the presented ad (e.g., by “clicking” the ad), the user is generally taken to another location associated with the ad, for example, to another, particular web page.

### SUMMARY

This specification describes technologies relating to content presentation.

In general, one aspect of the subject matter described in this specification can be embodied in methods that include the actions of presenting a content item to a user; receiving a user input indicating a voice interaction; receiving a voice input from the user; transmitting the voice input to a content system; receiving a command responsive to the voice input; and executing, using one or more processors, the command including modifying the content item. Other embodiments of this aspect include corresponding systems, apparatus, and computer program products.

These and other embodiments can optionally include one or more of the following features. The content item can be an advertisement. Receiving a user input indicating a voice interaction includes receiving a user input selecting a voice icon associated with the content item. Receiving a user input indicating a voice interaction includes monitoring movement and orientation of a mobile device. Executing the command includes executing logic to modify the presentation of the content item. Modifying the presentation of the content item includes changing content item text. Modifying the presentation of the content item includes changing color of one or more content item elements. Modifying the presentation of the content item includes changing an image associated with the content item. The method further includes transmitting a conversion to the content item system.

In general, one aspect of the subject matter described in this specification can be embodied in methods that include the actions of sending ads to a device for presentation; receiving a voice input associated with one of the ads sent to the device; processing the voice input to identify an ad command; and sending the ad command to the device, the ad command executable to reconfigure the one ad. Other embodiments of this aspect include corresponding systems, apparatus, and computer program products.

These and other embodiments can optionally include one or more of the following features. The method further includes logging a conversion for the ad after the ad command is identified. Processing the voice input further comprises: converting the voice input into text; and matching one or more terms from the text to terms associated with an ad command. The method further includes receiving a conversion for the ad from the device in response to the sent ad command. The method further includes identifying the ad associated with the voice input, where identifying the ad includes determining recent ads sent to the device.

Particular embodiments of the subject matter described in this specification can be implemented to realize one or more of the following advantages. Vocal interactions with a content item (e.g., ad) allow users to interact on devices having limited inputs, for example mobile devices. Additionally, voice intractable content items encourage users to interact with content items in order to promote conversions.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a diagram of an example content presentation system.

FIG. 2 shows a block diagram of an example system including an application for a mobile device.

FIG. 3 is a block diagram of an example voice ad interaction system.

FIG. 4 is an example mobile interface including a voice interactable ad.

FIG. 5 is a flow chart of an example process for voice ad interaction.

FIG. 6 is a flow chart of an example process for voice ad interaction.

FIGS. 7A-7B are example mobile interfaces including the voice interactable ad of FIG. 4 after a command has been received.

FIG. 8 is a block diagram of an example voice ad interaction system.

FIG. 9 is a flow chart of an example process for voice ad interaction.

Like reference symbols in the various drawings indicate like elements.

### DETAILED DESCRIPTION

Content items can be displayed in various forms on a user device, (e.g. a mobile phone, PDA, desktop computer). In some implementations, the device allows a user to interact with the content item using vocal commands. The vocal commands can be processed using speech to text functionality in order to convert the vocal commands into text. The text can be compared to a set of commands associated with the content item to determine if any of the vocal commands are a match for any of the ad commands. If a command is identified, the content item can execute the identified command. In some implementations, executing of the ad command includes changing the appearance of the content item. In some implementations, the user indicates that a vocal command is to occur by selecting an icon, pressing one or more keys, performing a specified motion, or positioning the device in a specified orientation (e.g., holding a mobile phone up to the user's ear). While reference will be made below to advertising systems and methods, other forms of content including other forms of sponsored content can be managed and presented in accordance with the description below.

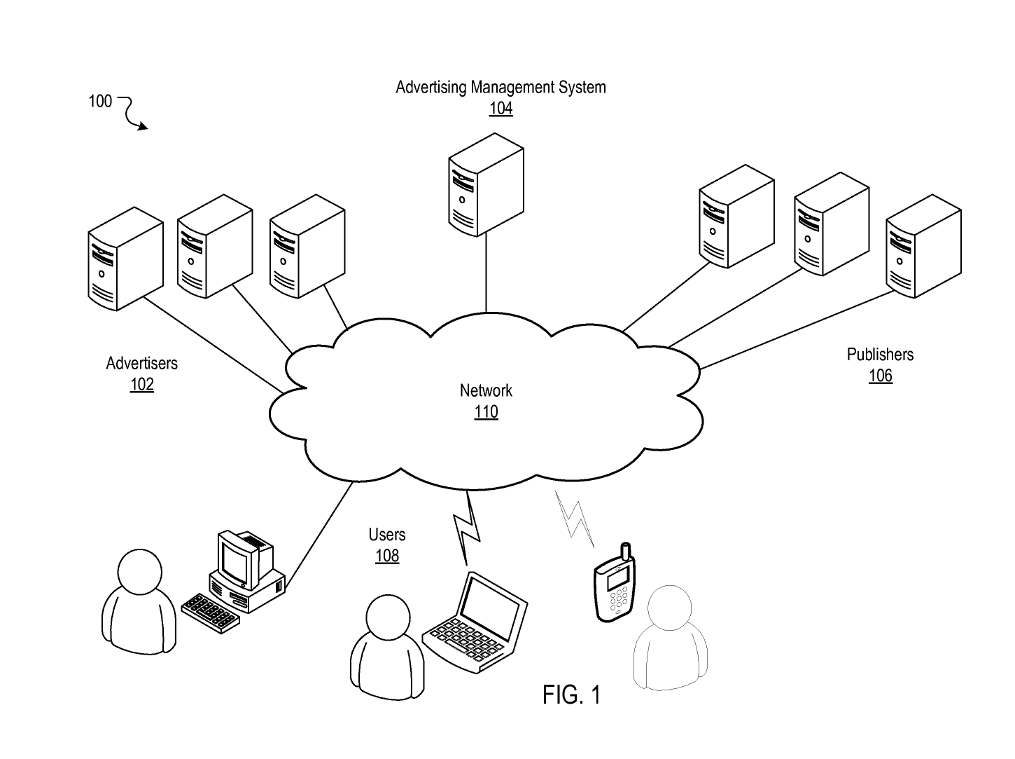

FIG. 1 is a block diagram of an example content presentation system 100. In some implementations, one or more advertisers 102 can directly, or indirectly, enter, maintain, and track ad information in an advertising management system 104. Though reference is made to advertising, other forms of content, including other forms of sponsored content, can be delivered by the system 100. The ads can be in the form of graphical ads, such as banner ads, text only ads, image ads, audio ads, video ads, animated ads, barcode ads, ads combining one or more of any of such components, etc. The ads can also include embedded information, such as links, meta-information, and/or machine executable instructions. One or more publishers 106 may submit requests for ads to the system 104. The system 104 responds by sending ads to the requesting publisher 106 for placement on or association with one or more of the publisher's content items (e.g., web properties). Example web properties can include web pages, television and radio advertising slots, or print media space.

Other entities, such as users 108 and the advertisers 102, can provide usage information to the system 104, such as, for example, whether or not a conversion (e.g., a purchase) or a click-through related to an ad (e.g., a user has selected an ad) has occurred. This usage information can include measured or observed user behavior related to ads that have been served. The system 104 may perform financial transactions, for example, crediting the publishers 106 and charging the advertisers 102 based on the usage information.

A network 110, such as a local area network (LAN), wide area network (WAN), the Internet, one or more telephony networks, or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for ads to an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser combines the requested content with one or more of the ads provided by the system 104. The combined content and ads can be sent/rendered to the users 108 that requested the content for presentation in a viewer (e.g., a browser or other content display system). The content server can transmit information about the ads back to the advertisement server, including information describing how, when, and/or where the ads are to be rendered (e.g., in HTML or JavaScript™).

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number can depend, for example, on the search results, the amount of screen or page space occupied by the search results, the size and shape of the ads, etc. The request for ads may also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores are computed from, for example, dot products of feature vectors corresponding to a query and a document, page rank scores, and/or combinations of IR scores and page rank scores, etc.

In some implementations, the advertisement management system 104 can use an auction process to select ads from the advertisers 102. For example, the advertisers 102 may be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a particular script (e.g., javascript) when the publisher's web page is loading on a client device.

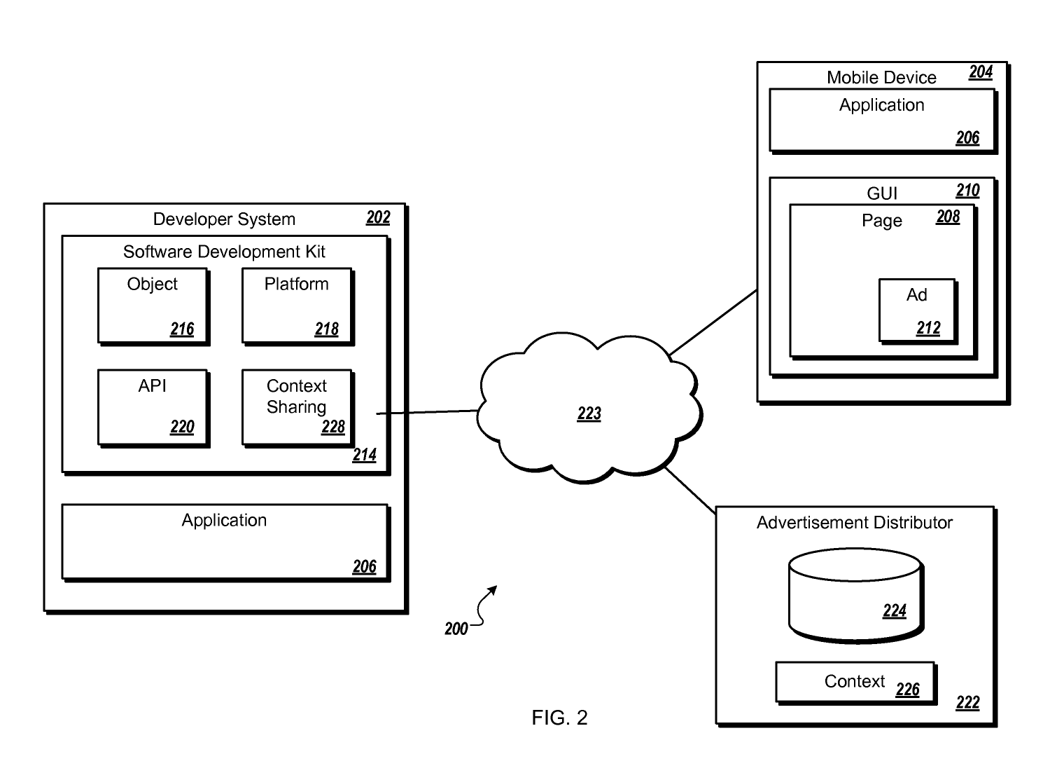

Another example publisher 106 is a mobile application developer. A mobile application is an application specifically designed for operation on a mobile device (e.g., a smart phone). The mobile application can also include ads positioned within the content of the mobile application. Similar to publishers 106 described above, the ads can be received from the system 104 for placement in the mobile application when accessed by a user (e.g., when a particular page of a mobile application is loaded on the mobile device). Mobile applications are described in greater detail below with respect to FIG. 2.

FIG. 2 shows a block diagram of an example system 200 including an application for a mobile device. In this example, a developer system 202 can be used by a developer to create program content including applications for one or more mobile devices 204, e.g., as a cellular telephone, a personal digital assistant or any other type of mobile device. Particularly, the developer can create an application 206, for example, by generating program code and compiling it into an executable program compatible with the mobile device 204. The application 206 can be formulated so that it presents one or more pages 208 in a graphical user interface 210 of the mobile device 204, for example, on a display screen. Examples below illustrate how the developer can configure the application 206 so that content 212, such as an advertisement from a third party, can be presented on the page(s) 208 when the application 206 is being executed.

A software development kit 214 can be provided to the developer for creating the application 206 and/or other programs. The software development kit 214 can provide editors for code and/or pseudocode, one or more compiling functions, emulating functions for previewing display content, and a debugging function, to name a few examples. In some implementations, the software development kit 214 is configured to provide the developer a convenient way of adding third-party content e.g., advertisements to a program created for mobile devices. For example, the software development kit 214 can provide the developer with the necessary code and/or other application content so that advertisements are requested, displayed to a user, and that any interaction between the user and the ad is tracked.

The software development kit 214 can provide one or more objects 216. In some implementations, the developer incorporates the object 216 in the code when creating the application. For example, the software development kit 214 can provide the object(s) 216 on a screen where the developer generates the overall application content in a way that the developer can select the object and include the corresponding material in the application as it is being created.

The software development kit can be configured so that the application(s) 206 can be created according to a particular platform 218. In some implementations, the platform 218 can be targeted to mobile devices, for example, to the type of the mobile device 204 e.g., a cell phone, a handheld device, a personal digital assistant, etc. For example, the platform 218 can be a platform created or supported by the Open Handset Alliance. In some implementations, the object 216 is included before the application code is compiled into an executable program. For example, the object can be incorporated as an integrated part of the application by inserting code before compilation.

The object 216 can perform one or more functions. In some implementations, the object causes third party content such as the advertisement(s) 212, to appear on the mobile device 204. For example, the object 216 can be responsible for requesting relevant ad(s), displaying the ad(s) in the right manner to the user, and tracking whether the user clicks on the ad or otherwise interacts with the ad.

In some implementations, the object 216 is a Java object that is configured to be added to a user interface of the application 206 and handle fetching and rendering of, and interaction with, content e.g., advertisements. For example, the developer can implement a view object that extends a view class associated with the application 206. Alternatively, in some implementations, the object 216 is an objective C object.

An application program interface (API) 220 can be used with the object 216. In some implementations, the API is a Java API that a developer can call when incorporating content such as advertisements into the application 206. For example, the object 216 can include a Java code snippet that uses the Java API 220 so that the developer can insert the code into the application 206. As noted earlier, such a code snippet can construct a request for content such as an ad based on a developer's customization, fetch the content and write it to the user interface of the application 206.

The ad 212 can include any kind of content. In some implementations, ad types including, but not limited to, text ads, image ads, and video ads can be used. For example, the ad can provide for user navigation (e.g., a link) to other content associated with the advertiser. Other types of content are possible (e.g., non-advertising content).

An advertisement distributor system 222 can be used to forward any type of content such as the ad 212 to the mobile device 204 and/or the developer system 202. In some implementations, the advertisement distributor system 222 is configured to receive request(s) for content from the mobile device 204, fetch one or more matching ads or other content from a repository 224, and forward the matching content to the mobile device. For example, the matching of the ad 212 can be performed using a context component 226, which can provide one or more context parameters associated with the application 206 configured for identifying matching content/advertisements.

The developer system 202, the mobile device 204 and/or the advertisement distributor system 222 can be connected using any kind of network 223, such as the Internet that is accessed by way of a wireless communication network.

Relevant context of the application 206 and/or the mobile device 204 can be shared in different ways. In some implementations, the developer can share context including metadata about the application 206 with the advertisement distributor system 222. A context sharing component 228 in the software development kit 214 can allow the developer to enter one or more keywords that the developer decides are relevant for retrieving and presenting content such as advertisements. For example, the developer who creates the application can submit the keyword(s) using the context sharing component 228 for receipt by the context component 226 for storage. In some implementations, monitoring can be performed to determine how well the submitted metadata correlates with the application 206 and if necessary, modifications in the used context parameter(s) can be made. In some implementations, context can be shared by the developer submitting the application 206 or portion thereof (e.g., relevant screen shot of the user interface to be presented with the advertisement content) to the advertisement distributor system 222. The context sharing component 228 can be used in submitting some or all of the application 206 for use in evaluating context.

The following is an example of how an implementation as described above can be used. A developer can create the application 206 intended for the mobile device 204 using the software development kit 214. Particularly, the application 206 can be created according to the platform 218 and can include the object 216. The developer can forward the application 206 to the mobile device for use, for example when the device 204 is initially sold or as a later update, such as by a download process. The developer can also provide context relating to the application 206, such as by submitting one or more keywords and/or providing a version of the application 206 or UI's associated with the application, using the context sharing component 228. One or more context parameters can be registered at the advertisement distribution system 222.

When a user operates the mobile device 204, content such as one or more ads 212 can be presented on the page(s) 208. The content can be selected for presentation by the advertisement distribution system 222 based on the context parameter(s). In some implementations, the user can interact with the ad(s) 212 in one or more ways, such as by clicking on the ad 212, performing a developer-specified combination of key presses (e.g., tapping a single key twice, or tapping two keys in rapid succession), or tapping on the ad on a touch screen device.

Content such as advertisements can be retrieved in any of a variety of ways. In some implementations, content can be retrieved essentially according to an on-demand approach. For example, ads or other content can be requested from the advertisement distribution system 222 and forwarded from there for display virtually immediately. Such implementations can have the advantage that the ad that is displayed to the user can be very current to the particular state of the application 206 and/or the mobile device 204.

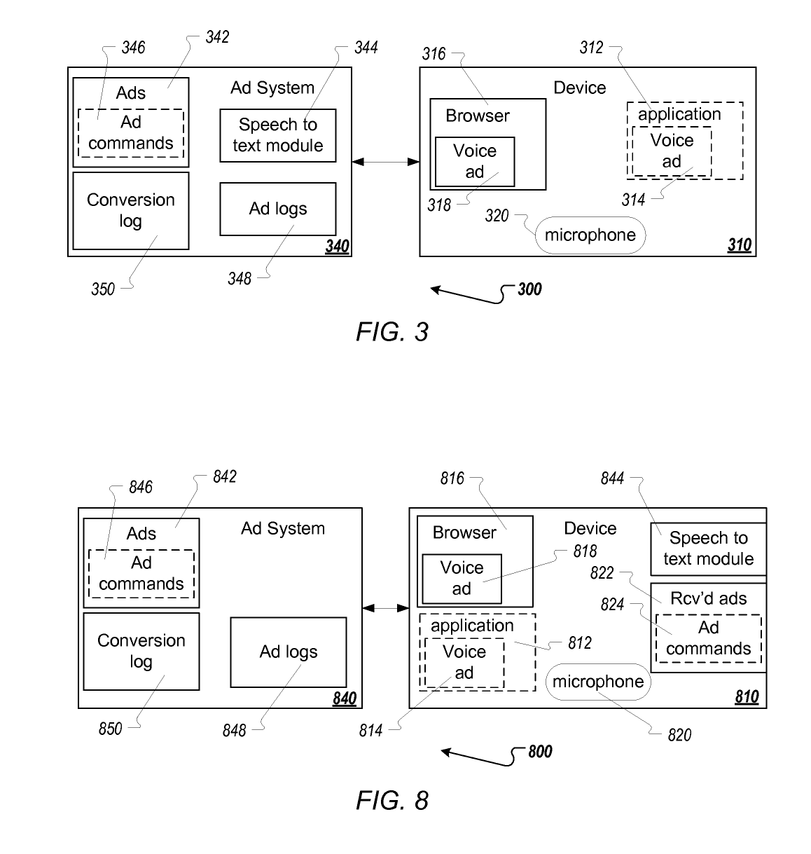

FIG. 3 is a block diagram of an example voice ad interaction system 300. The voice ad interaction system 300 includes an ad distribution system 340. For example, the ad distribution system 340 can be the advertisement distributor 222 shown in FIG. 2. As another example, the ad distribution system 340 can be the advertising management system 104 shown in FIG. 1. The system 300 further includes a device 310. For example, the device can be a mobile device such as a cellular telephone, a personal digital assistant or any other type of mobile device. As another example, the device 310 can be a computing device such as a desktop computer, laptop computer, or web enabled television. The device 310 is in communication with the ad distribution system 340 through a network, such as the Internet, a LAN, or a WAN.

The ad distribution system 340 includes ads 342 that can be provided to the device 310. In some implementations, at least a portion of the ads 342 provided by the ad distribution system 340 are ads capable of voice interaction with a user, or “voice ads.”

In some implementations, a browser 316 of the device 310 displays a voice ad 318 to the user. In some implementations, the voice ads 314 and 318 can be banner ads, graphical ads, text ads, video ads, audio ads, animated ads, or any combination of these ads.

Additionally, or alternatively, in some implementations, the device 310 can also present the ads 342 provided by the ad distribution system 340 to a user of the device 310 in association with an application running on the device 310 as described above with reference to FIG. 2. For example, the device 310 can include an application 312 that displays a voice ad 314 to the user. The voice ad can be targeted at the user based on contextual information associated with the application 312 or information about the user.

In some implementations, the user can interact with the voice ads 314 and 318 using voice inputs that can correspond to particular ad commands. For example, the voice ad 314 can pose a question to the user and allow the user to respond to the question vocally. The device 310 can be equipped with a microphone 320 for receiving voice inputs from the user. For example, if the device 310 is a cell phone, the microphone used by the cell phone for facilitating voice communications can be used as the microphone 320. As another example, a Bluetooth head set in communication with the device 310 can serve as the microphone 310. As yet another example, a desktop computer can be connected to a head set that includes the microphone 320. The user can wear the head set in order to speak into the microphone 320.

In some implementations, in order to provide a spoken input responsive to a voice ad, the user interacts with an icon associated with the voice ad. For example, a voice response icon (e.g., an image of a microphone) can be displayed by the voice ad 318 that the user can select to indicate that the user wishes to provide a vocal response to the voice ad 318. As another example, the application 312 can display an icon of a microphone which the user can select to indicate that he or she wishes to provide a voice input for use by the voice ad 314. Other ways of indicating a desire to provide a vocal response are possible. In some implementations, the device 310 allows the user to use a hot key or combination of keystrokes to indicate that the user wishes to give a voice input in association with a voice ad. For example, the user can use a keyboard connected to the device to indicate that he or she wishes to give a voice response in association with a voice ad.

In some implementations, the device 310 detects a motion of the device 310 in order to determine that the user wishes to give a voice input in association with a voice ad. For example, if the device 310 is a mobile phone, a motion sensor, accelerometer, position sensor, or proximity sensor of the device 310 can determine that the user is holding the device 310 up to his or her face so as to speak into the microphone 320 of the mobile phone.

In still other implementations, the device 310 can passively listen at an appropriate time (e.g., just after display of the ad or when the user moves an mouse or pointer over the ad) for voice inputs whenever a voice ad is displayed by the device 310 (e.g., the microphone can be activated when the voice ad is displayed). In such implementations, the user does not need to indicate that he or she wishes to provide a voice input in association with a voice ad. The user can simply speak the voice input and the microphone 320 can receive the voice input. Alternatively, the passive listening can be performed to identify particular types of user input that are not necessarily associated with ad commands, for example, user comments on the ad appearance or presentation (e.g., a user saying “this is a cool ad”).

In some implementations, the device 310 provides one or more voice inputs received from the user by the microphone 320 to the ad distribution system 340. For example, the device 310 can provide one or more audio files including one or more received voice inputs to the ad distribution system 340. The ad distribution system 340 processes the audio information to identify one or more voice inputs. For example, the ad distribution system 340 can use a speech to text module 344 to convert the voice inputs received by the microphone 320 into text. The ad distribution system 340 can then match the text of the voice input spoken by the user to possible ad commands 346 associated with an advertisement to identify one or more particular ad commands to invoke.

For example, the voice ad 314 includes text that poses the question “Who played Dorothy in the Wizard of Oz?” The user can tap on a microphone icon displayed as part of the voice ad 314 to indicate that he or she wishes to give a voice input and say “Diane Keaton,” which can be detected by the microphone 320. The device 310 transmits the user's response to the ad distribution system 340. The user's response is converted to text by the speech to text module 344. The ad distribution system 340 can then determine if the user's response matches any specified ad commands 346. For example, ad commands 346 associated with the voice ad 314 can indicate that a response of “Judy Garland” is correct and any other response is incorrect.

Thus, the ad distribution system 340 determines if the name “Judy Garland” is included in the text conversion of the user's spoken response. In this example, since the user said “Diane Keaton,” the ad distribution system 340 can indicate to the device 310 (e.g., by sending a corresponding command to be executed by the ad) that the wrong answer was given and the voice ad 314 can indicate to the user that a wrong answer was given. For example, the voice ad 314 can dynamically change to display the text “Better Luck Next Time” in response to the received command.

As another example, if the user gives the correct answer, the ad distribution system 340 can provide the device 310 with a corresponding command to be executed by the ad indicating that the correct answer has been given and the voice ad 314 can dynamically change to indicate to the user that the answer spoken by the user is correct. For example, the voice ad 314 can change to display the text “You're Correct!” and offer a coupon or discount to the user for providing a correct answer.

In some implementations, the device 310 provides identifying information to the ad distribution system 340 that allows the ad distribution system 340 to identify the voice ad 318 that is being displayed to the user (e.g., along with or contemporaneous to the audio files being sent). For example, the device 310 can provide an ad identifier (“adID”) (e.g. an ad cookie from the browser 316) for the voice ad 318 to the ad distribution system 340, which indicates to the ad distribution system 340 that the voice ad 318 is being displayed to the user and that a voice input received from the device 310 is associated with the voice ad 318.

As another example, the device 310 provides a device identifier (“deviceID”) (e.g. a hardware ID, a network ID, IP address, or telephone number) for the device 310 to the ad distribution system 340. The ad distribution system 340 can keep ad logs 348 associated with one or more devices that are in communication with the ad distribution system 340. The ad distribution system 340 can use the ad log 348 for the device 310 to identify ads that have recently been supplied to the device 310. For example, the ad distribution system 340 can use the ad log 348 to determine that the voice ad 318 is the most recent voice ad provided to the device 310. The ad distribution system 340 can then associate a voice inputs received from the device 310 with the voice ad 318. In some implementations, the device 310 provides the identifying information to the ad distribution system 340 along with one or more voice inputs spoken by the user.

In some implementations, the ad distribution system 340 uses the identity of the voice ad associated with one or more voice inputs received from the device 310 to identify a set of ad commands 346 associated with the voice ad. The ad commands 346 can define a set of commands that are accepted as valid commands in association with the particular voice ad. For example, the device 310 can display the voice ad 314 to the user and receive a voice input from the user. In this example, the voice ad 314 displays a car and poses the question “What color gets you fired up?” The user then selects a voice command or voice input icon and says “blue,” which is detected by the microphone 320. The device 310 provides a deviceID for the device 310 along with the voice input to the ad distribution system 340.

The ad distribution system 340 uses ad logs 348 to identify the voice ad 314 as the voice ad currently being displayed by the device 310. The ad distribution system 340 identifies a collection of ad commands 346 associated with the voice ad 314, in this case, a list of colors. The speech to text module 344 converts the voice input into text. The ad distribution system 340 then compares the text of the voice input to text associated with the ad commands 346 for the voice ad 314 (e.g., command keywords or the command itself) to determine if the voice input corresponds to the text associated with one of the ad commands 346. In this example, the ad distribution system 340 can determine that the user said “blue” and that “blue” is included in the text associated with ad commands 346.

The ad distribution system 340 can then send a command associated with the user's voice input to the device 310. Following the above example, the ad distribution system 340 can match the user's input of “blue” to an associated command that is sent to the device 310 for execution by the voice ad 314. For example, the ad distribution system 340 can send an ad command of “change color to blue” to the device 310. The voice ad 314 can then execute the command by changing the color of the displayed car to blue. In some implementations, voice ads displayed by the device 310 include executable code for interpreting commands indicated by the ad distribution system 340 and executing the commands.

As another example, the voice ad 314 can pose the question “What ride do you want for Christmas?” while displaying an image of a sports car. The user gives a voice response of “I want a big truck” which is provided to the ad distribution system 340 along with an indication of the voice ad 314. The speech to text module 344 converts the voice input response to text and the ad distribution system 340 compares the text to the ad commands 346 associated with the voice ad 314 to determine if the response includes any recognized command words. The ad distribution system 340 identifies “truck” as associated with a valid ad command 346 for the voice ad 314 and identifies the word “truck” within the text of the voice response given by the user. The ad distribution system 340 provides the corresponding ad command to the device 310. The voice ad 314 can then execute the command by displaying an animation of the sports car driving out of view followed by a truck driving into view to replace the sports car.

In some implementations, the device 310 continues to receive voice inputs from the user in association with a voice ad even after the voice ad has changed appearance in response to a first voice input given by the user. Following the above example, after the voice ad 314 has changed to replace the sports car with a truck, the user can say “make that a black motorcycle.” The ad distribution system 340 converts the user's voice input to text and identifies the words “black” and “motorcycle” as being included in the list of valid ad commands 346 for the voice ad 314. The ad distribution system 340 indicates to the device 310 that the user's voice input included “black” and “motorcycle.” The voice ad 314 can then display an animation of the truck driving out of frame and a black motorcycle driving into frame.

In some implementations, the ad distribution system 340 can provide advertisers with one or more interaction templates to use when creating voice ads. For example, the interaction templates can indicate sets of ad commands 346 that can be associated with voice ads. For example, a first interaction template can provide a set of ad commands 346 that include a list of colors and a second interaction template can provide a set of ad commands 346 that include a list of sports related commands. The advertisers can then create voice ads based on ad commands 346 provided in the interaction templates. In other implementations, advertisers can create voice ads without the use of interaction template, or indicate ad commands 346 in addition to those included in an interaction template.

In some implementations, the ad distribution system 340 includes a thesaurus functionality in order to better match a voice input given by the user to a valid ad command 346 for a voice ad. The thesaurus functionality can allow the ad distribution system 340 to match a voice input to an ad command 346 that has a similar meaning Following the above example, the user can say “pickup.” The speech to text module 344 converts the user's response to text and thesaurus functionality of the ad distribution system 340 identifies “pickup” as being a synonym for truck. As another example, the voice ad 318 can ask for the user's favorite type of food and the user can say “lasagna” in response. Thesaurus functionality of the ad distribution system 340 can identify “lasagna” as a type of Italian food. The ad distribution system 340 can then identify “Italian” as a valid ad command 346 for the voice ad 318. As yet another example, a voice ad presents a yes or no question and thesaurus functionality of the ad distribution system 340 can determine that “sure,” “yeah,” and “okay” are equivalent to “yes” and that “nah,” and “I don't think so” are equivalent to “no.”

In some implementations, the device 310 can provide an indication of an ad conversion to the ad distribution system 340 along with a voice input or after a voice input has been sent to the ad distribution system 340. By indicating that a conversion has occurred, the device 310 is indicating to the ad distribution system 340 that the user has interacted with a voice ad. In some implementations, the ad distribution system 340 includes a conversion log 350 for recording when a conversion for a particular ad has occurred. Other types of conversions are possible.

For example, the user can provide a voice input corresponding to a particular voice input associated with the voice ad 318. The device 310 then indicates to the ad distribution system 340 that a conversion has occurred along with the corresponding voice input. In some implementations, the device 310 provides an adID for the voice ad 318 so that the ad distribution system 340 can associate the conversion with the voice ad 318. In some other implementations, the ad distribution system 340 uses the ad logs 348 and a deviceID for the device 310 to determine that the conversion is to be associated with the voice ad 318. The ad distribution system 340 then indicates in the conversion log 350 that a conversion has occurred for the voice ad 318. For example, the conversion log 350 may be a database, hash table, lookup table, or spread sheet.

In some implementations, rather than being associated with a particular advertisement, the conversion is associated with an advertiser. For example, if the voice ad 314 is an ad for Example Company ltd. and a conversion occurs, the ad distribution system 340 associates a conversion with Example Company ltd. rather than the specific voice ad 314. In some implementations, additional information is stored in the conversion log 350. For example, the conversion log 350 can indicate whether a conversion is associated with a voice ad or a “standard” ad. This can prove beneficial when different rates are charged for different types of advertisements.

In some implementations, the device 310 does not send an indication of a conversion to the ad distribution system 340 until the device 310 has received one or more commands from the ad distribution system 340. For example, the speech to text module 344 converts a voice input received from the device 310 to text and identifies a valid ad command 346 within the text of the voice input. The ad distribution system 340 then provides the identified ad command 346 to the device 310 for execution by the voice ad.

In some implementations, upon receiving the command, the device 310 provides an indication of a conversion to the ad distribution system 340. This can help to prevent an advertiser from being charged for a conversion when an indication of a command is not actually received by the device 310. For example, after providing a voice input to the ad distribution system 340, the device 310 may become disconnected from a communication network or lose power. This can prevent the ad distribution system 340 from communicating an indication of an ad command 346 to the device 310. In such situations, the voice ad displayed by the device 310 would not change in response to the user's voice input since the device 310 did not receive the indication of the ad command 346 from the ad distribution system 340.

In some implementations, the device 310 does not send an indication of a conversion to the ad distribution system 340 until a command received from the ad distribution system 340 has been executed. For example, the speech to text module 344 converts a voice input associated with the voice ad 318 to text and identifies a valid ad command 346 within the text of the voice input. The ad distribution system 340 then provides the identified ad command 346 to the device 310 for execution by the voice ad 318. After the voice ad 318 has executed the received ad command 346, the device 310 provides an indication of a conversion to the ad distribution system 340.

In some implementations, the ad distribution system 340 can determine that a conversion has occurred based on a server side event rather than a client side event. For example, the ad distribution system 340 can determine that a conversion has occurred when a voice input is received from the device 310. As another example, the ad distribution system 340 can determine that a conversion has occurred if one or more ad commands 346 have been identified as matching a voice input provided by the device 310.

In some implementations, the device 310 can determine that a conversion has occurred in association with a passive voice interaction with the ad. For example, a user can view the voice ad 314 and say “cool ad.” As described above, the ad can initiate a passive listening when displayed. The device 310 provides the voice input to the ad distribution system 340 where it is converted to text by the speech to text module 344. The ad distribution system 340 determines that “cool ad” is positive feed back for the voice ad 314. In some implementations, this can indicate that the user has interacted with the voice ad 314 and a conversion has occurred. In some implementations, a positive or negative voice input spoken by the user can be used in determining a rating quality for a voice ad. For example, if the user gives a voice input of “sweet ad,” the ad distribution system 340 can increase the rating of an associated voice ad. As another example, if the user gives a voice input of “this is boring,” the ad distribution system 340 can decrease a rating of an associated voice ad.

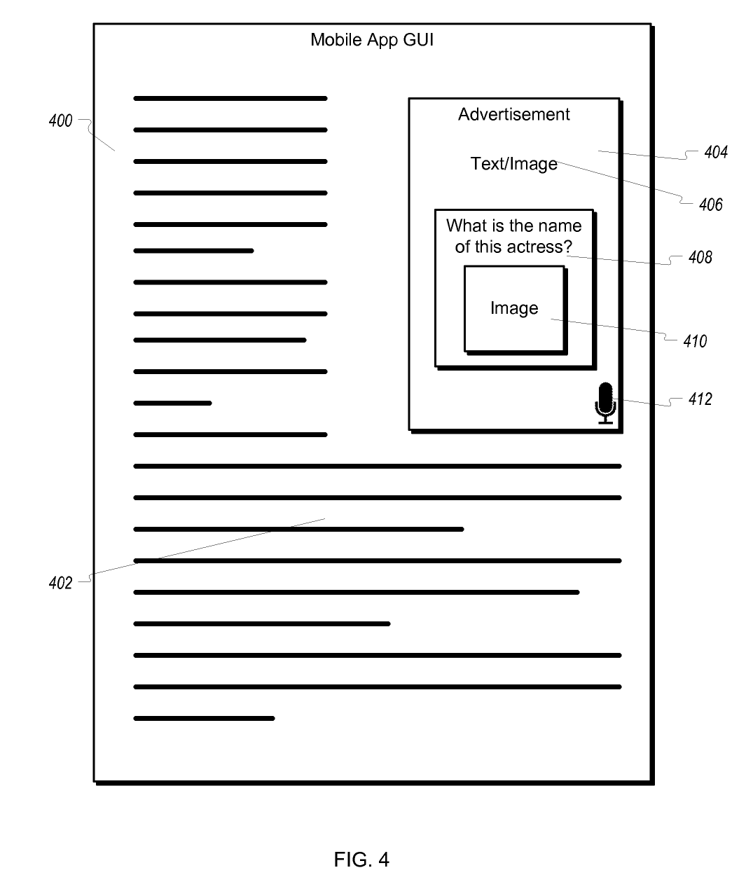

FIG. 4 shows a mobile GUI 400 for display on a mobile device. The mobile GUI 400 can be a presentation of a mobile application, an application displayed on a non-mobile device, a web page displayed within a browser, or another graphic display of content. The mobile GUI 400 includes content 402 and an ad 404 displayed alongside the content 402. For example, the content 402 can be web content, such as text and images contained within a web page. As another example, the content 402 can be application content, such as text or graphics displayed as part of a video game.

The ad 404 is displayed in proximity to the content 402 and includes ad content 406 such as text, images, video, audio, or animation. In some implementations, the ad content 406 relates to a particular product or service that is being advertised. In some implementations, the ad 404 is selected so as to be targeted to a user of the mobile GUI 400. For example, the ad 404 can be selected as being relevant to the content 402. The ad 404 additionally includes voice interaction prompt 408. The voice interaction prompt 408 poses a question to a user of the mobile GUI 400 in order to elicit a voice response from the user. In the example shown, the voice interaction prompt 408 displays a question of “What is the name of this actress?” along with an image 410 of an actress.

In some implementations, the user indicates a desire to give a vocal response for the question posed by the voice interaction prompt 408 by selecting an icon 412 displayed as part of the ad 404 (e.g., an icon represented by an image of a microphone). In other implementations, the icon 412 can be displayed elsewhere within the mobile GUI 400. In still other implementations, the user can indicate a desire to give a vocal response by pressing one or more designated buttons or keys.

In still other implementations, the user can indicate a desire to give a vocal response by holding a mobile device that is displaying the mobile GUI 400 up to his or her face. In such implementations, a positioning module, a location module, a motion sensing module, an orientation module, or any combination can determine that the user has positioned the mobile device near his or her face, or that the mobile device is positioned in a position that is receptive to voice communication. In some implementations, the user need not indicate a desire to give a vocal response. In such implementations, a device that is displaying the mobile GUI 400 can passively listen for voice input given by the user.

After the user has indicated a desire to give a vocal response for the question posed by the voice interaction prompt 408, the user can give a voice input by speaking into a microphone attached to the device that is displaying the mobile GUI 400. The ad 404 can then react to the response given by the user, for example, by changing appearance. For example, if the user gives a correct response to the question, the ad 404 can display text of “You're right!” and present the user with a coupon or special offer. As another example, if the user gives an incorrect response, the ad 404 can display text of “WRONG” or display a new question for the user to answer.

In some implementations, the ad 404 can react to voice inputs given by the user that do not directly address the voice interaction prompt 408. For example, rather than answering the question posed by the voice interaction prompt 408, the user can say “purple” to cause the background color of the ad 404 to change to purple. As another example, the user can say “French” to cause the text displayed by the ad 404 to be converted to French. As yet another example, the user can say “map” or “location” to cause the ad 404 to display a map that shows locations of nearby retailers that sell a product advertised by the ad 404. In this example, a GPS unit of a device that displays the mobile GUI 400 can be used to determine a location of the device and locations of retailers that are near the device. As another example, user information for the user, such as a home address or work address, can be used to determine a map location to display in the ad 404.

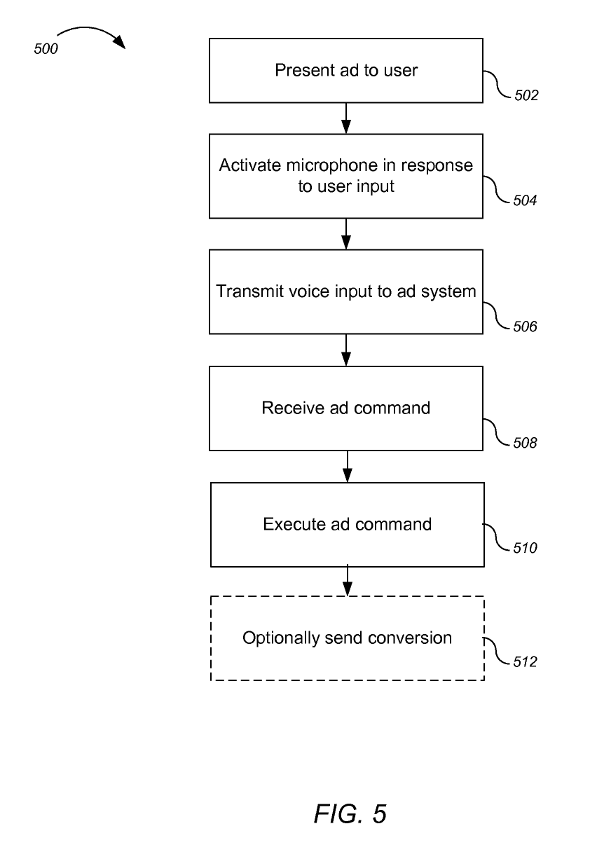

FIG. 5 is a flow chart of an example process 500 for voice ad interaction. In some implementations, the process 500 can be performed by a user device such as the device 310 shown in FIG. 3 or the mobile device 204 shown in FIG. 2. At step 502 an ad is presented to a user. For example, referring to FIG. 4, the ad 404 is presented to a user alongside content 402 displayed within the mobile GUI 400. As another example, referring to FIG. 3, the browser 316 of the device 310 displays the voice ad 318. The ad presented to the user can include information about products or services available for purchase. The ad can also include a prompt to elicit a voice input in response from the user. For example, the ad can pose a question to the user.

At step 504, a microphone is activated in response to user input. For example, referring to FIG. 4, the user can select the icon 412 using a touch screen or mouse. As another example, referring to FIG. 3, the user holds the device 310 to their face to indicate that they wish to give a voice input responsive to the ad. The device 310 detects the position and activates the microphone 320 in response to the position. As yet another example, the user presses a button on a mobile device to activate the microphone. In still another example, the user can hit one or more keys on a keyboard to activate the microphone.

At step 506 a voice input is transmitted to an ad system. For example, referring to FIG. 3, the microphone 320 can detect one or more voice inputs spoken by the user. The device 310 then transmits the voice inputs to the ad distribution system 340. In some implementations, the voice inputs are transmitted as audio files. As another example, referring to FIG. 2, the mobile device 204 receives a voice input from the user and transmits the voice input to the advertisement distributor 222 through the network 223. As yet another example, referring to FIG. 1, a user device being used by one of the users 108 can detect a voice input given by the user 108. The user device can then transmit the voice input through the network 110 to the advertising management system 104.

At step 508, an ad command is received. For example, referring to FIG. 2, the mobile device 204 can receive an ad command from the advertisement distributor 222 using the network 223. As another example, referring to FIG. 3, the device 310 can receive the ad command from the ad distribution system 340. In some implementations, the ad distribution system 340 determines the ad command by converting the voice input to text using the speech to text module. The ad distribution system 340 then compares the translated text to one or more ad commands 346 associated with the ad to identify an ad command 346 that corresponds to a word or phrase spoken by the user. The ad distribution system 340 then sends the identified ad command 346 to the device 310. For example, the user can say “where can I buy this?” The ad distribution system 340 can identify valid ad commands 346 of “where” and “buy” and transmit these ad commands 346 to the device 310. As another example, the ad distribution system 340 can identify the words of “where” and “buy” as being associated with a command word 346 of “location.” The ad distribution system 340 can then transmit the command word 346 “location” to the device 310.

At step 510, the ad command is executed. In some implementations, the ad processes the command in order to execute particular action code for the ad. For example, the ad can include a mapping of ad commands to action code. The particular action code to execute is selected based on the ad command identified for the received voice input. The command execution by the ad results in a modification to the presentation of the ad (e.g., a changing or re-rendering of the ad, adding an overlay presentation, etc). In some implementations, the ad code includes alternative forms that can be switched to for presentation according to the particular command. Alternatively, the code can dynamically render a modified version of the ad.

For example, referring to FIG. 4, if the ad command is “blue,” the ad 404 can execute the command by changing the color of text displayed within the ad 404 to blue. As another example, referring to FIG. 3, the voice ad 314 can display an image of a hat and the device 310 can receive an ad command of “feathers” from the ad distribution system 340. The voice ad 314 can execute the ad command by changing the image of the hat to include feathers. As yet another example, a device can receive an ad command of “location.” The device can execute the command by activating a map application and indicating retailers that are located nearby where a product presented by an advertisement can be purchased. As yet another example, referring to FIG. 4, the ad 404 can execute an ad command of “price” by displaying one or more retail prices for products presented by the ad 404. In still another example, an device can execute an ad command of “link” by displaying a web page that is linked to by an ad.

At optional step 512, a conversion is sent. For example, referring to FIG. 3, the device 310 can send a conversion to the ad distribution system 340. The ad distribution system 340 can then record the conversion in the conversion log 350. In some implementations, the conversion indicates that the user has interacted with an ad. This information can be used to pay content providers or charge advertisers.

In some implementations of the process 500, more or fewer steps can be performed or one or more steps can be performed in a different order. For example, optional step 512 of sending a conversion can be performed after step 506 of transmitting a voice input to an ad system.

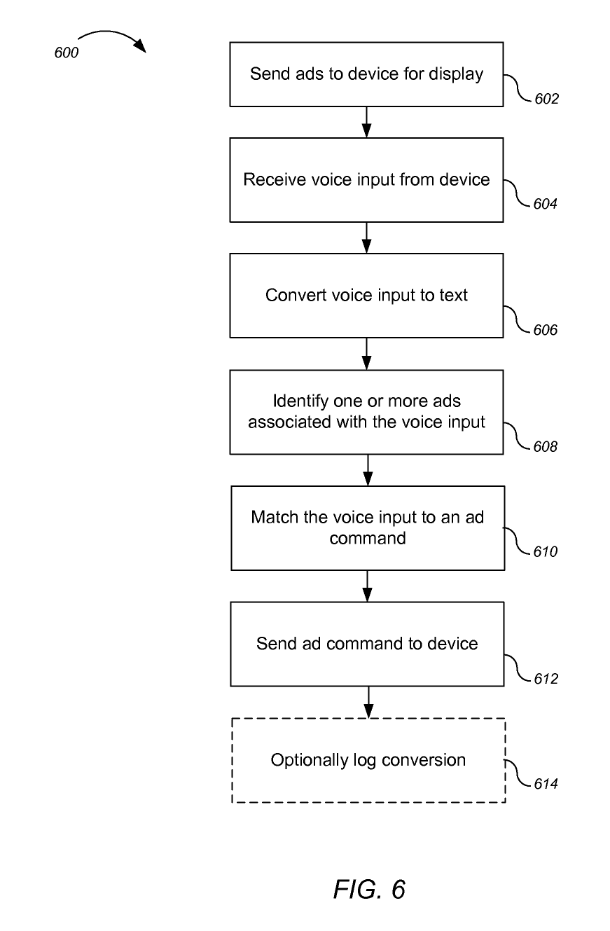

FIG. 6 is a flow chart of an example process 600 for voice ad interaction. In some implementations, the process 600 can be performed by an advertisement system e.g., the ad distribution system 340 shown in FIG. 3 or the advertisement distributor 222 shown in FIG. 2. At step 602, an ad is sent to a device for display. For example, referring to FIG. 1, the advertising management system 104 can provide advertising content to the users 108. As another example, referring to FIG. 2, the advertisement distributor 222 can provide the ad 212 to the mobile device 204 through the network 223.

At step 604 a voice input is received from a device. For example, referring to FIG. 3, the ad distribution system 340 receives a voice input from the device 310. The voice input may be spoken by a user and recorded and/or transmitted by the device 310 using the microphone 320. As another example, referring to FIG. 2, the advertisement distributor 222 receives a voice input from the mobile device 204 through the network 223. In some implementations, the voice input is a response to a prompt or question presented by an ad. For example, referring to FIG. 4, a user can give a voice input in response to the voice interaction prompt 408.

At step 606 the voice input is optionally converted to text. For example, referring to FIG. 3, the speech to text module 344 of the ad distribution system 340 can convert the received voice input to text. In some implementations, a Hidden Markov Model method or a Dynamic Time Warping method can be used to convert the voice input to text.

At step 608 one or more ads associated with the voice input are identified. For example, referring to FIG. 3, the ad distribution system 340 can receive an adID (e.g. an ad cookie from a browser) from the device 310 that indicates voice ad 318. As another example, the ad distribution system 340 can use a deviceID for the device 310 to identify an ad log 348 associated with the device 310. The ad distribution system 340 can use the ad log 348 to identify one or more ads that have recently been provided to the device 310. The ad distribution system 340 can identify a most recently provided voice ad as being associated with the voice input.

As another example, the ad distribution system 340 can identify multiple recently provided voice ads as being associated with the voice input, for example, because multiple ads can be sent to the device within a small period of time (e.g. in batches). As another example, more than one ad can be displayed by a device at one time. Therefore, a voice input given by the user may be in reference to any of the currently displayed voice ads. In this example, the multiple voice ads may share the same or similar sets of ad commands 346. In some implementations, one or more sets of ad commands that are associated with the identified ads can be identified. In some implementations, ads within the ad logs 348 can be identified based on a userID rather than a deviceID.

At step 610 the voice input is matched to an ad command. For example, referring to FIG. 3, the ad distribution system 340 compares the text generated at step 606 to a set of ad commands 346 associated with the one or more ads identified at step 608. The ad distribution system 340 can determine if the voice input matches any of the ad commands 346. For example, if the voice input is “make it turn yellow,” the ad distribution system 340 can identify an ad command of “change text to yellow” as being a match for the voice input. In some implementations, the ad distribution system 340 can determine if any words or phrases included in the voice input are similar in meaning to text or keywords associated with ad commands 346 for the one or more identified ads. For example, if the voice input includes “make it spin,” the ad distribution system 340 can identify an ad command 346 of “rotate” as a matching ad command for the voice input.

At step 612, the ad command is sent to the device. For example, referring to FIG. 1, the advertising management system 104 can send the identified ad command to one of the users 108 through the network 110. As another example, referring to FIG. 3, the ad distribution system 340 can transmit the ad command to the device 310. In some implementations, the device 310, or a voice ad displayed by the device 310, can execute the command.

At optional step 614, a conversion is logged. For example, referring to FIG. 3, the ad distribution system 340 can receive an indication of a conversion from the device 310. In some implementations, the device 310 can send the conversion when a user of the device 310 provides a voice input in association with a voice ad. In some other implementations, the device 310 can send the conversion when an ad command received from the ad distribution system 340 is executed. The ad distribution system 340 can log the conversion in the conversion log 350.

In still other implementations, the ad distribution system 340 does not wait to receive an indication of a conversion from the device 310. In such implementations, the ad distribution system 340 can log a conversion upon identifying a matching ad command for the voice input, for example. Information that can be logged can include an adID for the associated ad, an indication of an advertiser associated with the ad, a deviceID for the device 310, a user ID of a user of the device 310, and the type of ad (e.g. voice ad, standard ad, video ad, audio ad, etc.).

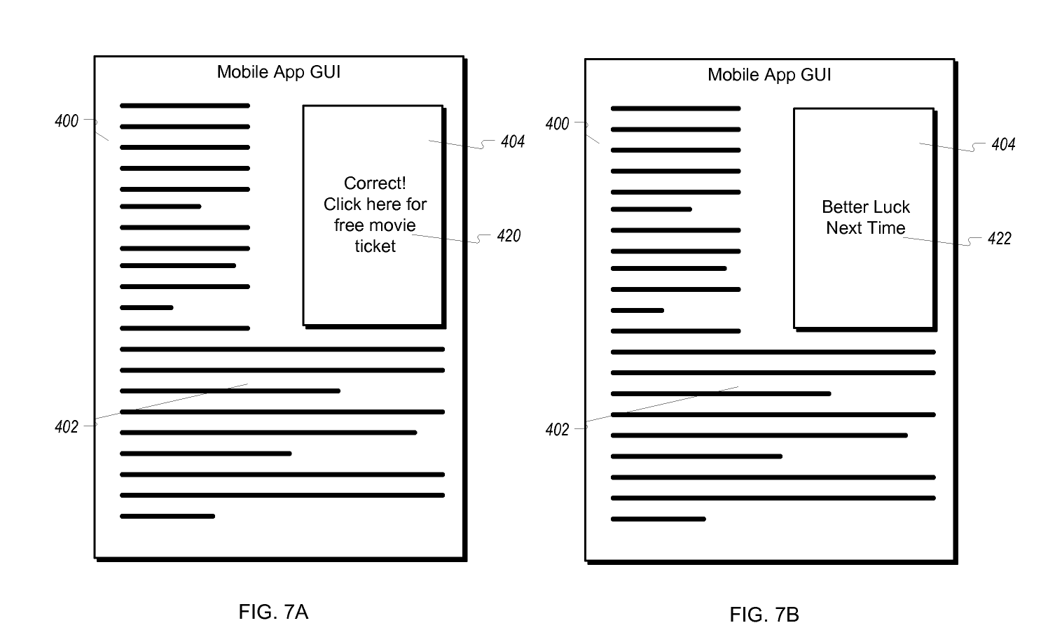

FIGS. 7A-7B are example mobile interfaces including the voice interactable ad of FIG. 4 after a command has been received. FIG. 7A shows the mobile device GUI 400 of FIG. 4 after a correct response has been given by a user viewing the mobile GUI 400. Referring to FIG. 4, the ad 404 included a voice interaction prompt 408 which included a question of “What is the name of this actress?” In this example, the image 410 can be a picture of Audrey Hepburn. The user can give a voice input in response to the question of “that's a picture of Audrey Hepburn.” An associated system can identify the words “Audrey Hepburn” in the response given by the user and identify them as the correct response. A device displaying the mobile GUI 400 can then receive an indication that a correct answer has been given. For example, the device can receive a “display correct result message” command. The ad 404 can execute the command by displaying a message 420 of “Correct! Click here for free movie ticket.” For example, the user can then select the ad 404 to be redirected to a page that includes a free movie ticket.

FIG. 7B shows the mobile device GUI 400 of FIG. 4 after an incorrect response has been given by a user viewing the mobile device GUI 400. Following the example above, the user can give a voice response of “Elizabeth Taylor.” An associated system can determine that the voice input given by the user does not include the words “Audrey Hepburn” and indicate to a device displaying the mobile device GUI 400 that an incorrect answer has been given. In response to the indication of an incorrect answer being given, the ad 404 can display a message 422 of “Better Luck Next Time.” In some implementations, the ad 404 can present a new question for the user to answer. In some implementations, the user can select the ad 404 in order to view more information about an advertised product. For example, if the ad 404 is advertising a particular fast food chain, selecting the ad 404 can cause a browser to display a website for the fast food chain.

FIG. 8 is a block diagram of an example voice ad interaction system 800. The system 800 includes an ad distribution system 840. For example, the ad distribution system 840 can be the advertisement distributor 222 shown in FIG. 2. As another example, the ad distribution system 840 can be the advertising management system 104 shown in FIG. 1. The system 800 further includes a device 810. The device can be, for example, a cellular telephone, personal digital assistant, desktop computer, laptop computer, or web enabled television. The device 810 is in communication with the ad distribution system 840 through a network, e.g., the Internet, a LAN, or a WAN.

The ad distribution system 840 includes ads 842 that can be provided to the device 810. In some implementations, at least a portion of the ads 842 provided by the ad distribution system 840 are ads capable of voice interaction with a user, or “voice ads.” In some implementations, the ad distribution system 840 provides sets of ad commands 846 associated with the ads 842 to the device 810. The device 310 can store received ads 822 and associated ad commands 824. The ad commands 824 can define sets of commands that can executed in association with one or more of the received ads 822. For example, an ad command 824 of “rev” can be associated with a received ad 822 that displays an image of a motor cycle. The received ad 822 can execute the ad command 824 of “rev” by playing an audio file of an engine revving.

The device 810 can present one or more of the received ads 822 to a user of the device 810 in association with an application running on the device 810 as described above with reference to FIG. 2. For example, the device 810 can include an application 812 that displays a voice ad 814 to the user. As another example, a browser 816 of the device 810 can display a voice ad 818 to the user. In some implementations, the voice ads 814 and 818 can be banner ads, graphical ads, text ads, video ads, audio ads, animated ads, or any combination of these ads.

In some implementations, the device 810 allows the user to interact with the voice ads 814 and 818 using voice inputs. For example, the voice ad 814 can pose a question to the user and allow the user to respond to the question vocally. In such implementations, the device 810 can be equipped with a microphone 820 for receiving voice inputs from the user. For example, if the device 810 is a cell phone, the microphone used by the cell phone for facilitating voice communications can be used as the microphone 820. As another example, a desktop computer can be connected to a head set that includes the microphone 820 for receiving voice inputs from the user.

In some implementations, in order to provide a spoken command for a voice ad, the user selects an icon. For example, the application 812 can display an icon of a microphone which the user can select to indicate that he or she wishes to speak a vocal command for use by the voice ad 814. As another example, an voice response icon can be displayed by the voice ad 818 that the user can select to indicate that the user wishes to provide a vocal response to the voice ad 818. In other implementations, the device 810 can passively listen for voice inputs whenever a voice ad is displayed by the device 810 in order to detect voice inputs spoken by the user.

In some implementations, the device 810 includes a speech to text module 844 for converting voice inputs received by the microphone 820 into text. The ad device 810 can then match the text of the voice inputs spoken by the user to possible ad commands 824 associated with a received ad 822 to identify an ad command associated with the voice input.

For example, the voice ad 814 includes text that poses the question “What team does Lebron James play for?” The user can tap on a microphone icon displayed as part of the voice ad 814 to indicate that he or she wishes to give a voice input and say “the Denver Nuggets” which can be detected by the microphone 820. The user's response is converted to text by the speech to text module 844. The device 810 can then determine if the user's response matches any predefined ad commands 824. The device 810 can identify a set of ad commands 824 that are associated with the voice ad 814. For example, ad commands 824 associated with the voice ad 814 can indicate that responses of “Bulls,” or “Chicago Bulls” are correct and any other response is incorrect.

The device 810 determines if the word “Bulls” is included in the text conversion of the user's spoken response. In this example, since the user said “Denver Nuggets,” the device 310 can provide an ad command 824 of “display incorrect answer message” to the voice ad 814. The voice ad 814 can execute the ad command 824 by indicating to the user that a wrong answer was given. For example, the voice ad 814 can display the text “Better Luck Next Time.” As another example, if the user gives the correct answer, the device 810 can indicate the device 310 can provide an ad command 824 of “display correct answer message” to the voice ad 814. The voice ad 814 can execute the ad command 824 by indicating to the user that the answer spoken by the user is correct. For example, the voice ad 814 can display the text “That's Right!” and offer a coupon or discount to the user for providing a correct answer.

As another example, the voice ad 818 can be an advertisement for boots. The user can provide the voice input of “map” which can be detected by the microphone 820. The speech to text module 844 converts the voice input to text and the device 810 determines if the word “map” matches any ad commands 824 that are identified as being associated with the voice ad 818. The device 810 can identify an ad command 824 of “display retailers on map” as matching the voice input of “map.” The device 810 provides the identified ad command 824 to the voice ad 818. The voice ad 818 executes the ad command 824 by displaying a map that shows the current location of the device 810 (for example, by using a GPS unit of the device) and indicates nearby retailers that sell the boots indicated in the voice ad 818.

In some implementations, the device 810 provides an indication of an ad conversion to the ad distribution system 840 upon identifying an ad command 824 associated with a received ad 822 that matches a voice input given by the user. By indicating that a conversion has occurred, the device 810 is indicating to the ad distribution system 840 that the user has interacted with a voice ad. In such implementations, the ad distribution system 840 can include a conversion log 850 for recording when a conversion for a particular ad has occurred. For example, the voice ad 818 running on the device 810 can execute an ad command 824 identified by the device 810. The device 810 then indicates to the ad distribution system 840 that a conversion has occurred. In some implementations, the device 810 provides an adID for the voice ad 818 so that the ad distribution system 840 can associate the conversion with the specific voice ad 818.

In some implementations, the ad distribution system 840 can keep ad logs 848 associated with one or more devices that are in communication with the ad distribution system 840. The device 810 can provide a deviceID to the ad distribution system 840, which the ad distribution system 840 can then use to identify an ad log 848 associated with the device 810. The ad distribution system 840 can use the ad log 848 for the device 810 to identify ads that have recently been supplied to the device 810. For example, the ad distribution system 840 can use the ad log 848 to determine that the voice ad 818 is the most recent voice ad provided to the device 810. The ad distribution system 840 can then associate a conversion received from the device 810 with the voice ad 818. The ad distribution system 840 can indicate in the conversion log 850 that a conversion has occurred for the voice ad 818. For example, the conversion log 850 may be a database, hash table, lookup table, or spread sheet.

In some implementations, rather than being associated with a particular advertisement, the conversion is associated with an advertiser. For example, if the voice ad 814 is an ad for a particular type of sneaker provided by a shoe company and a conversion occurs, the ad distribution system 840 associates a conversion with the shoe company generally rather than the specific voice ad 814. In some implementations, additional information is stored in the conversion log 850. For example, the conversion log 850 can indicate whether a conversion is associated with a voice ad or a “standard” ad. This can prove beneficial when different rates are charged for different types of advertisements.

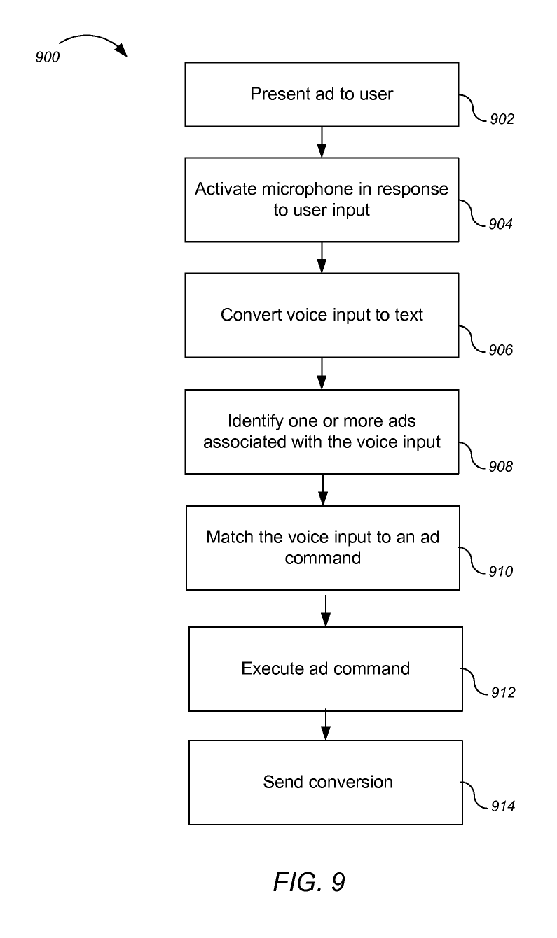

FIG. 9 is a flow chart of an example process 900 for voice ad interaction. In some implementations, the process 900 can be performed by a user device such as the device 810 shown in FIG. 8 or the mobile device 204 shown in FIG. 2. At step 902 an ad is presented to a user. For example, referring to FIG. 4, the ad 404 is presented to a user alongside content 402 displayed within the mobile GUI 400. As another example, referring to FIG. 8, the browser 816 of the device 810 displays the voice ad 818. The ad presented to the user can include information about products or services available for purchase. The ad can also include a prompt to elicit a voice response from the user. For example, the ad can pose a question to the user.

At step 904, a microphone is activated in response to user input. For example, referring to FIG. 4, the user can select the icon 412 using a touch screen or mouse. As another example, referring to FIG. 8, the user holds the device 810 to their face to indicate that they wish to give a voice input. The device 810 detects that the user has moved the device 810 to a relative proximity of the user's face and activates the microphone 820 in response to the motion. As yet another example, the user presses a button on a mobile device to activate the microphone. In still another example, the user can hit one or more keys on a keyboard to activate the microphone.

Optionally, at step 906 the voice input is converted to text. For example, referring to FIG. 8, the speech to text module 844 of the device 810 can convert the received voice input to text using any of a number of known methods.

At step 908 one or more ads associated with the voice input are identified. For example, referring to FIG. 8, the device 810 can determine that the voice ad 814 is currently being displayed by the application 812. The device 810 can identify a received ad 822 that corresponds to the voice ad 814, for example, by using an adID for the voice ad 814. As another example, the device 810 can determine that both the voice ads 814 and 818 are currently being displayed and that the voice input could relate to either or both of the voice ads 814 and 818. The device 810 can identify received ads 822 that correspond to the voice ads 814 and 818.

At step 910 the voice input is matched to an ad command. For example, referring to FIG. 8, the device 810 compares the text generated at step 906 to a set of ad commands 824 associated with the one or more received ads 822 identified at step 908. The device 810 can determine if the voice input matches any of the ad commands 824. For example, if the voice input is “show me a stripped shirt,” the device 810 can identify an ad command of “display stripped shirt” as being a match for the voice input. In some implementations, the device 810 can determine if any words or phrases included in the voice input are similar in meaning to ad commands 824 that are associated with the one or more identified received ads 822. For example, if the voice input includes “make it spin,” the device 810 can identify an ad command 824 of “rotate” as a matching ad command for the voice input.

At step 912, the ad command is executed. For example, referring to FIG. 4, if the ad command is “change to blue,” the ad 404 can execute the command by changing the color of text displayed within the ad 404 to blue. As another example, referring to FIG. 8, the voice ad 814 can display an image of a radio and question of “what music do you like.” The device 810 can identify an ad command of “punk” as matching a voice input given by the user. The voice ad 814 can execute the ad command by playing a punk song and displaying an animation of a punk rocker walking into frame and picking up the radio. As yet another example, a device can identify an ad command of “location” as matching the voice input. The device can execute the command by activating a map application and indicating retailers that are located nearby where a product presented by an advertisement can be purchased. As yet another example, referring to FIG. 4, the ad 404 can execute an ad command of “price” by displaying one or more retail prices for products presented by the ad 404.

At step 914, a conversion is sent. For example, referring to FIG. 8, the device 810 can send a conversion to the ad distribution system 840. In some implementations, the device 810 can include an adID for an ad associated with the conversion or an advertiserID for an advertiser associated with the conversion to the ad distribution system 840. In other implementations, the device 810 can provide the ad distribution system 840 with a deviceID for the device 810 or a userID for a user of the device 810. The ad distribution system 840 can identify ads within the ad logs 848 using the deviceID or userID. The ad distribution system 840 can a voice ad that has recently been provided to the device 810 based on the ad logs 848 and associate the conversion with the identified voice ad. The ad distribution system 840 can then record the conversion in the conversion log 850.

In some implementations of the process 900, more or fewer steps can be performed or one or more steps can be performed in a different order. For example, step 912 of sending a conversion can be omitted, or performed after step 910 of matching the voice input to an ad command.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
presenting a content item to a user;
receiving a user input indicating a voice interaction;
receiving a voice input from the user;
transmitting the voice input to a content system;
receiving a command responsive to the voice input; and
executing, using one or more processors, the command including modifying the content item.

2. The method of claim 1, where the content item is an advertisement.

3. The method of claim 1, where receiving a user input indicating a voice interaction includes receiving a user input selecting a voice icon associated with the content item.

4. The method of claim 1, where receiving a user input indicating a voice interaction includes monitoring movement and orientation of a mobile device.

5. The method of claim 1, where executing the command includes executing logic to modify the presentation of the content item.

6. The method of claim 5, where modifying the presentation of the content item includes changing content item text.

7. The method of claim 5, where modifying the presentation of the content item includes changing color of one or more content item elements.

8. The method of claim 5, where modifying the presentation of the content item includes changing an image associated with the content item.

9. The method of claim 1, further comprising:
transmitting a conversion to the content item system.

10. A method comprising:
sending ads to a device for presentation;
receiving a voice input associated with one of the ads sent to the device;
processing, using one or more processors, the voice input to identify an ad command; and
sending the ad command to the device, the ad command executable to reconfigure the one ad.

11. The method of claim 10, further comprising:
logging a conversion for the ad after the ad command is identified.

12. The method of claim 10, where processing the voice input further comprises:
converting the voice input into text; and
matching one or more terms from the text to terms associated with an ad command.

13. The method of claim 10, further comprising:
receiving a conversion for the ad from the device in response to the sent ad command.

14. The method of claim 10, further comprising:
identifying the ad associated with the voice input, where identifying the ad includes determining recent ads sent to the device.

15. A system comprising:
one or more processors configured to interact with a computer storage medium in order to perform operations comprising:
presenting a content item to a user;
receiving a user input indicating a voice interaction;
receiving a voice input from the user;
transmitting the voice input to a content system;
receiving a command responsive to the voice input; and
executing the command including modifying the content item.

16. The system of claim 15, where the content item is an advertisement.

17. The system of claim 15, where receiving a user input indicating a voice interaction includes receiving a user input selecting a voice icon associated with the content item.

18. The system of claim 15, where receiving a user input indicating a voice interaction includes monitoring movement and orientation of a mobile device.

19. The system of claim 15, where executing the command includes executing logic to modify the presentation of the content item.

20. The system of claim 19, where modifying the presentation of the content item includes changing content item text.

21. The system of claim 19, where modifying the presentation of the content item includes changing color of one or more content item elements.

22. The system of claim 19, where modifying the presentation of the content item includes changing an image associated with the content item.

23. The system of claim 15, further configured to perform operations comprising:
transmitting a conversion to the content item system.

24. A system comprising:
one or more processors configured to interact with a computer storage medium in order to perform operations comprising:
sending ads to the device for presentation;
receiving a voice input associated with one of the ads sent to the device;
processing the voice input to identify an ad command; and
sending the ad command to the device, the ad command executable to reconfigure the one ad.

25. The system of claim 24, further operable to perform operations comprising:
logging a conversion for the ad after the ad command is identified.

26. The system of claim 24, where processing the voice input further comprises:
converting the voice input into text; and
matching one or more terms from the text to terms associated with an ad command.

27. The system of claim 24, further operable to perform operations comprising:
receiving a conversion for the ad from the device in response to the sent ad command.

28. The system of claim 24, further operable to perform operations comprising:
identifying the ad associated with the voice input, where identifying the ad includes determining recent ads sent to the device.

29. A computer storage medium encoded with a computer program, the program comprising instructions that when executed by data processing apparatus cause the data processing apparatus to perform operations comprising:
presenting a content item to a user;
receiving a user input indicating a voice interaction;
receiving a voice input from the user;
transmitting the voice input to a content system;
receiving a command responsive to the voice input; and
executing the command including modifying the content item.

30. A computer storage medium encoded with a computer program, the program comprising instructions that when executed by data processing apparatus cause the data processing apparatus to perform operations comprising:
sending ads to the device for presentation;
receiving a voice input associated with one of the ads sent to the device;
processing the voice input to identify an ad command; and
sending the ad command to the device, the ad command executable to reconfigure the one ad.
